(19) United States
(12) Patent Application Publication
(10) Pub. No.: US 2008/0257796 A1
(43) Pub. Date: Oct. 23, 2008

(54) Control Module Array for Sorters

(75) Inventor: James Jukkola, Erie, PA (US)

Correspondence Address: EDWARD W. GOEBEL, JR.;MACDONALD, ILLIG, JONES & BRITTON LLP, 100 STATE STREET, SUITE 700, ERIE, PA, 16507-1498, US

(73) Assignee: Eriez Manufacturing Co.

(21) Appl. No.: 12/105,555

(22) Filed: Apr. 18, 2008

Related U.S. Application Data
(60) Provisional application No. 60/912,566, filed on Apr. 18, 2007.

(51) Int. Cl. B07C 5/00; G06F 19/00; B07C 5/36

(52) U.S. Cl. 209/576; 700/223; 209/606

(57) ABSTRACT

A control module is presented for a sorter for sorting materials from a material stream that can include a plurality of types of materials. The sorter comprises at least two control modules and each control module includes control circuitry, at least two sensors, and a corresponding sorting assembly for each sensor. Each sensor is capable of detecting at least one type of material in the material stream and is capable of transmitting data to and receiving signals from the control circuitry. Each sorting assembly is capable of being actuated by the control circuitry to substantially sort materials from the material stream based on the readings of the sensors. The control circuitry is capable of receiving signals from and transmitting signals to each sensor and each sorting assembly.

This application takes priority from U.S. provisional application 60/912,566 filed Apr. 18, 2007, which is incorporated herein by reference.

### BACKGROUND

The recycling industry sorts and separates reusable materials out of collected materials. The sorted and separated reusable materials are reprocessed into raw materials in other applications while the unusable material is typically sent to a landfill. Machines, called sorters, are often used to mechanically sort and separate a variety of types of materials from a material stream. The material stream is passed through the detection range of any of a variety of sensors that detect metals, plastics, glass, or other parameters like size and color that can be sorted and separated from the material stream.

### SUMMARY

A control module is presented for a sorter for sorting materials from a material stream that can include a plurality of types of materials. The sorter comprises at least two control modules and each control module includes control circuitry, at least two sensors, and a corresponding sorting assembly for each sensor. Each sensor is capable of detecting at least one type of material in the material stream and is capable of transmitting data to and receiving signals from the control circuitry. Each sorting assembly is capable of being actuated by the control circuitry to substantially sort materials from the material stream based on the readings of the sensors. The control circuitry is capable of receiving signals from and transmitting signals to each sensor and each sorting assembly.

In some embodiments, the control circuitry is able to monitor at least one of: a failure in the sensors, an open circuit in the sorting assembly, and whether each sorting assembly is stuck. It is also possible for the control circuitry of each control module to maintain logs of the activity and performance of each sensor and each sorting assembly.

The sensors can be configured to detect metal, plastics, glass, the size of the material in the material stream, the color of the material in the material stream, or other detectable parameters as required by the particular application.

Multiple control modules can be arranged into an array of control modules on sorters that have material handling systems to transport material streams across them. The sensors and sorting assemblies of the array of control modules can be arranged on the sorter to allow the detection and sorting of at least one type of material in the material stream substantially across the width of the material handling system. Various embodiments of arrays of control modules can have each module detecting and sorting a different component of the material in the material stream. Other embodiments can have arrays of control modules in which each control module utilizes a different sensor technology.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is an embodiment of a sorter that can incorporate an array of control modules as described herein;

FIG. 2 is a schematic showing a prior art control system of a sorter;

FIG. 3 is a schematic showing an embodiment of the control system of a sorter having four control modules with each control module having six sensors associated with six sorting assemblies;

FIG. 4 is a top cutout view of the sorter shown in FIG. 1 showing an array of control modules comprising sensors and paddles arranged across the width of the sorter's material handling system;

FIG. 5 is a perspective view of an embodiment of a sensor that could be used in a control module;

FIG. 6A is a perspective view of one embodiment of a sorting assembly that is a motorized paddle that could be used in a control module;

FIG. 6B is a perspective rear view of the motorized paddle of FIG. 6A;

FIG. 6C is a cross-sectional view of the motorized paddle of FIG. 6B along the Section line 6C-6C;

FIG. 7 shows a module of motorized paddles that incorporate sealing features for improved performance;

FIG. 8 is a graph showing the current reading over time of a motorized paddle properly actuating; and

FIG. 9 is a graph showing the current reading over time of a motorized paddle that is stuck.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

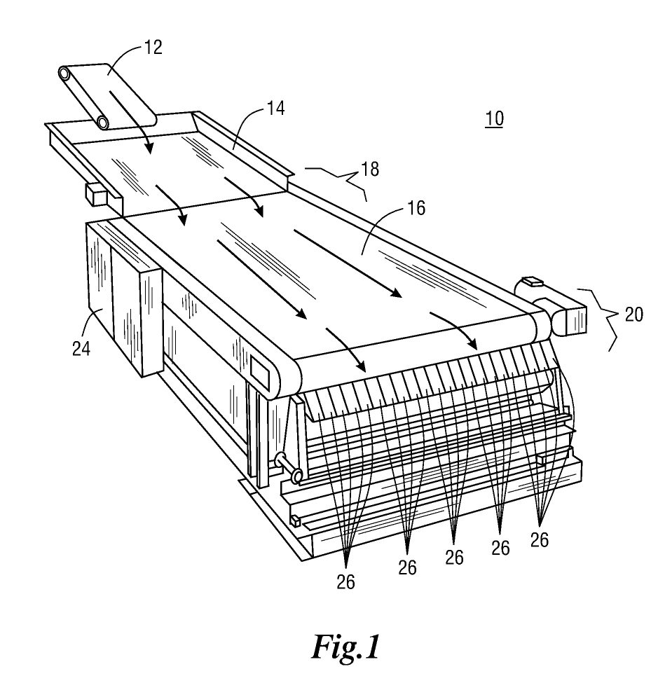

Sorters in the recycling industry use a variety of methods to detect and sort different types of material from a material stream. FIG. 1 shows an example of such a sorter 10. The sorter 10 is a ProSort manufactured by Eriez Magnetics. The sorter 10 accepts material from upstream sources 12 and has a material introduction system 14 that is a vibrating chute angled to deposit a material stream onto the width of a material handling system 16. The material handling system 16 comprises a conveyor belt that transports the material stream from about a first end 18 where the material stream is deposited to about a second end 20.

This sorter 10 has a material detection system that comprises at least one sensor located under the conveyor belt of the material handling system 16. The sensors are able to detect at least one type of material in the material stream within their range of effectiveness and are arranged to be effective substantially across the width of the material handling system. The sensor or sensors are controlled by a control system located in the control system housing 24. The sorter 10 is able to sort the material in the material stream based on the readings of the sensor or sensors. This sorting is conducted by a series of sorting assemblies that are motorized paddles assemblies 26. It will be understood that other sorting assemblies such as air sorters and other mechanisms known in the art could be used as other embodiments of the invention in place of the motorized paddle assemblies 26 shown and described herein.

The material stream passes through the detection range of the material detection system as it is conveyed from the first end 18 to the second end 20. When a sensor of the material detector detects a target type of material in the material stream, the control system in the control system housing 24 either sends a timed signal to the corresponding motorized paddle assembly 26 to deflect the material or does nothing and lets the material drop past the motorized paddle assemblies 26 as required by the current configuration of the sorter 10.

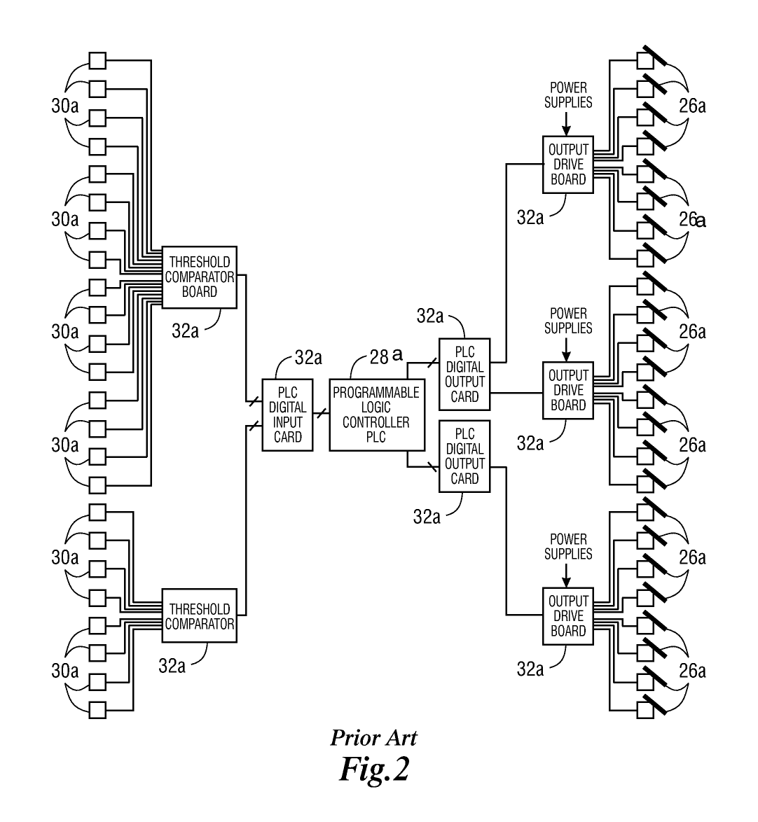

As shown in FIG. 2, the control of the sensor or sensor and the paddles in prior art sorters has been routed through a single Programmable Logic Controller (PLC) 28a. In this example, the PLC 28a communicates with the twenty-four sensors 30a and motorized paddle assemblies 26a through a series of step-wise interfaces 32a (the function each step is listed in FIG. 2, but is not discussed herein). Such a system is limited by the ability of the PLC 28a to be able to process and control information from and instructions to increasing numbers of sensors 30a and motorized paddle assemblies 26a.

Many prior art control systems use mechanical relays that have lower lifetimes, lower reliability, and slower reaction time than more modem solid-state electronics. The software programming is also much more difficult with larger sorters with more sensors 30a and motorized paddle assemblies 26a. A fault in any of the step-wise interfaces 32a or even the PLC 28a could affect the entire sorter. Furthermore, prior art controllers have not been implemented with the ability to monitor and diagnose the functioning of the motorized paddle assemblies 26a or the sensors 30a.

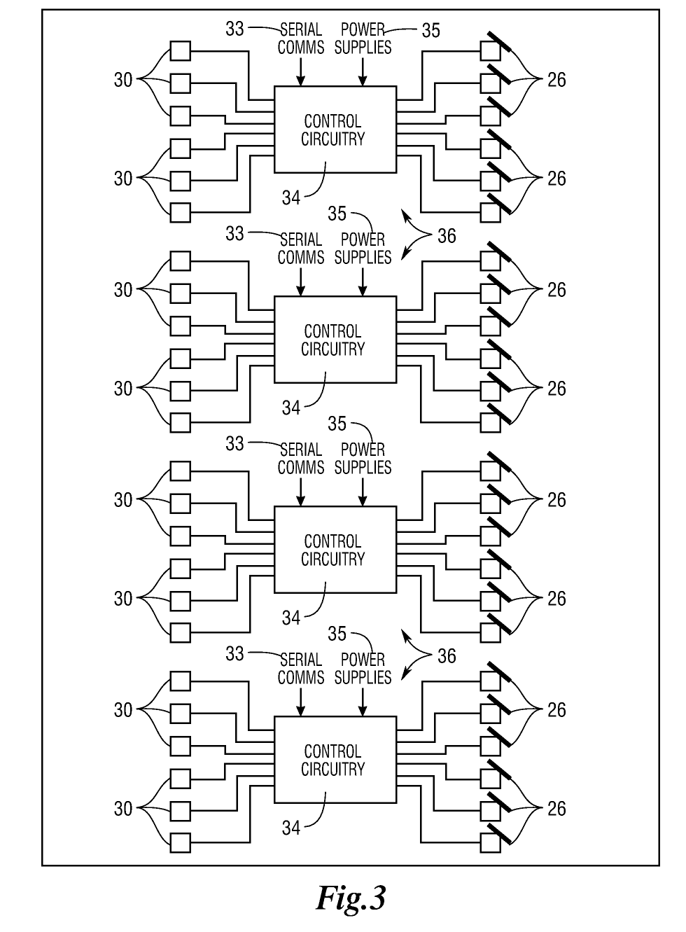

The schematic in FIG. 3 shows one embodiment of how a sorter (for example the sorter 10 shown in FIG. 1) having twenty-four sensors 30 and motorized paddle assemblies 26 can be controlled and operated. Each of the control modules 36 includes control circuitry 34, at least two sensors 30, with a corresponding motorized paddle assembly 26 for each sensor 30. In this embodiment, each control module 36 comprises six sensors 30 and six corresponding motorized paddle assemblies 26 that are controlled by common solid-state control circuits 34. Control circuitries 34 that incorporate solid-state circuits have longer life spans, greater reliability, and faster reaction time than mechanical relays. Each sensor 30 is capable of detecting at least one type of material in the sorter's material stream and is capable of transmitting data to and receiving signals from the control circuitry 34. Each motorized paddle assembly 26 is capable of being actuated by the control circuitry 34 to substantially sort materials from the material stream based on the readings of its corresponding sensor 30. The control circuitry 34 is capable of receiving signals from and transmitting signals to each sensor 30 and each motorized paddle assembly 26.

Each control module 36 has an independent serial communication outlet 33 and power supply 35. Typically each control module 36 is connected to a user interface (not shown) through the serial communication outlet 33. The operator of the sorter can monitor and program each control module independently through the user interface. This allows for a much shorter maintenance period over prior art control systems as problems with particular control modules 36 can be quickly identified and isolated without having to check each motorized paddle assembly 26 individually. Each control module 36 can operate independently of the other control modules 36 in a sorter so a fault that causes any control module 36 to fail completely will not shut down the entire sorter. In the example shown in FIG. 3, if two control modules 36 are taken out of commission for any reason, the sorter is still able to function at 50% capacity. Also such a catastrophic fault to a control circuit 34 would only require, at the most, the replacement of components of the affected control module 36 and not a replacement of the entire control system. Furthermore, if the items to be replaced require customization, it is easier to modify small units of standard modules than a single PLC with potentially many more parts to coordinate.

Having control modules 36 of standard sizes with standard numbers of sensors 30 and motorized paddle assemblies 26 creates economies of scale in manufacturing sorters 10 of different sizes and capacities. For example, assuming a standard control module 36 comprises six sensors 30 with six corresponding motorized paddle assemblies 26 that can control a width of about a foot on a sorter 10, it is easy to contemplate having sorters of different widths to be developed by adding additional control modules 36 to meet the requirements of the particular application. A sorter 10 that is two feet wide would require two control modules 36, a sorter 10 that is seven feet wide would require seven control modules, etc. The size and configuration of each control module 36 can be established based on manufacturing and marketing needs with customization as needed.

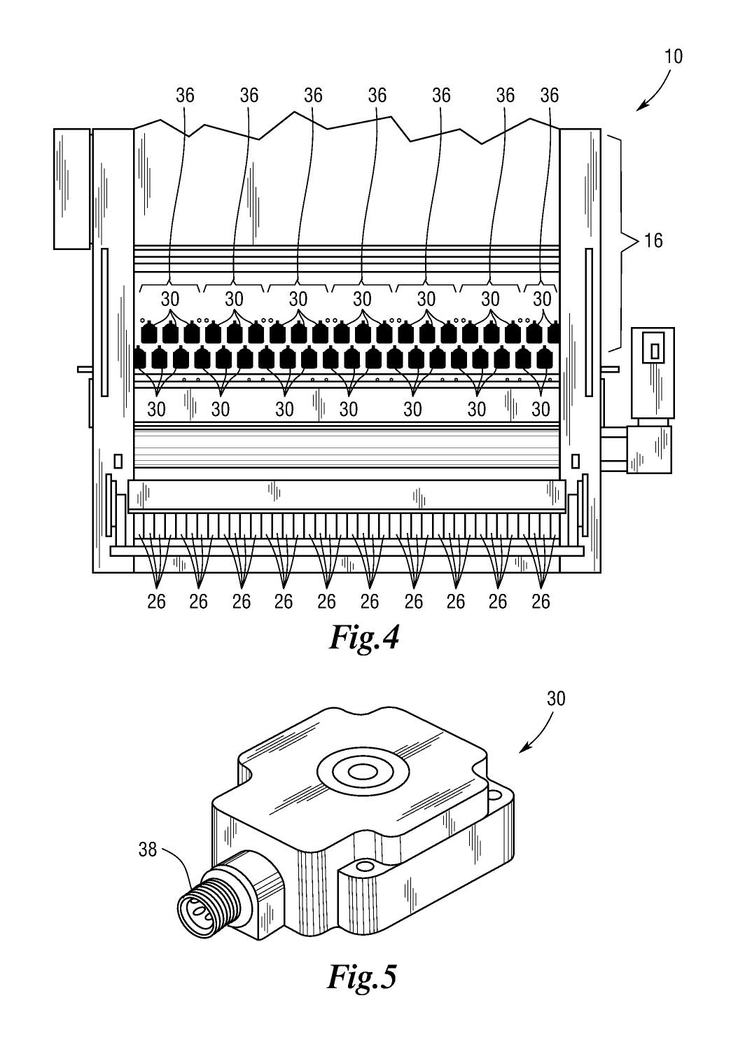

FIG. 4 shows a cross-sectional view of one layout of the control modules 36 schematic shown in FIG. 3 can be implemented in the ProSort machine shown in FIG. 1. As best understood by comparing FIGS. 1 and 4, FIG. 4 shows how the control modules 36 can be laid out under the material handling system 16. This embodiment comprises an array of seven control modules 36 across the width of the material handling system 16. Each control module 36 comprises six individual sensors 30, with the exception of the seventh module 36 that comprises four individual sensors 30. The sensors 30 are connected to their respective motorized paddle assemblies 26 through their control circuitry (not shown). Each set of sensors 30 is individually adjustable to detect a certain type of material in the material stream. The sensors 30 are arranged so that the sensor fields overlap. Such an arrangement is not required, but it does mean that a detectable component in the material stream is likely to trigger the activation of more than one motorized paddle assembly 26.

FIG. 5 shows an example of the sensors 30 used on the ProSort machine shown in FIGS. 1 and 3. The sensors 30 are typically inductive sensors (model number Ni50-Q80-LIU-H1141 manufactured by Turck) that can distinguish metals from non-metals and stainless steel from other metals. The sensor 30 is connected to the control circuitry (not shown) via a sensor cable connector 38. This sensor 30 functions by generating an electromagnetic field and then measuring the distortion in that field caused by nearby metal. But any other kinds of sensors detecting any other kinds of materials can be used. In general, the sensor could be any component or system that can distinguish one or more materials from other materials in the material stream, and produce a digital or analog signal to indicate the presence of the distinguished material. The sensor could detect metal, plastics, glass, the size of the material in the material stream, the color of the material in the material stream, or other detectable parameters. The sensors can comprise X-Ray Fluorescence systems that can detect a range of types of materials, optical detection systems that can optically detect materials in a material stream, near-infrared detection systems, or any other kind of detection technology. The sensors could also comprise a combination of technologies.

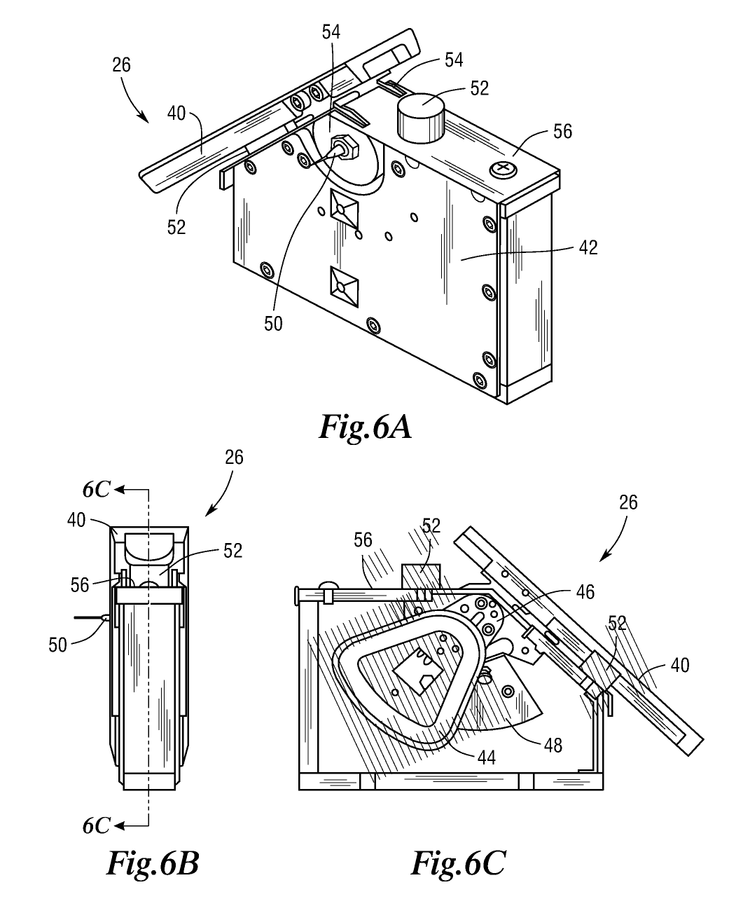

An example of the motorized paddle assemblies 26 is shown depicted in FIG. 6A. As can be best understood by comparing FIGS. 6A-6C, the motorized paddle assembly 26 comprises a paddle 40 with a housing 42. The paddle 40 is mounted to an electromagnetic coil 44 that is suspended from a shaft 46. The shaft 46 rides on bearings that allow the electromagnetic coil 44 to swing freely. The electromagnetic coil 44 is sandwiched between two sets of fixed permanent magnets 48 (only one set is shown in the figures). The electromagnetic coil 44 is close to the magnets 48 but does not touch them. There is a clearance of about 0.030 inches on either side of the electromagnetic coil 44 between the magnets 48 and the electromagnetic coil 44. The motorized paddle assembly 26 is connected to the module's control circuitry (not shown) through the motorized paddle assembly cable connector 50.

Motorized paddle assemblies 26 of the type shown in FIGS. 6A-6C operate in high dust and grit environments. Magnetic particles in the dust or grit may affect the operation of the magnets 48, the electromagnetic coil 44, or the control circuitry (not shown). Dust and grit buildup can also physically impede the range of motion of the paddles 40 or damage any cable connections to the motorized paddle assembly 26. In order to reduce the chances of the motorized paddle assemblies 26 getting stuck, the hinges 54 on which the paddle 40 rotates are made to be circular. This reduces the chance that any dust that falls behind the hinge 54 will impede the range of motion of the paddle 40. To further reduce the chances of grit or dust collecting behind the hinge 54, a top plate 56 with openings sized to fit the hinges 54 is incorporated into the housing 42.

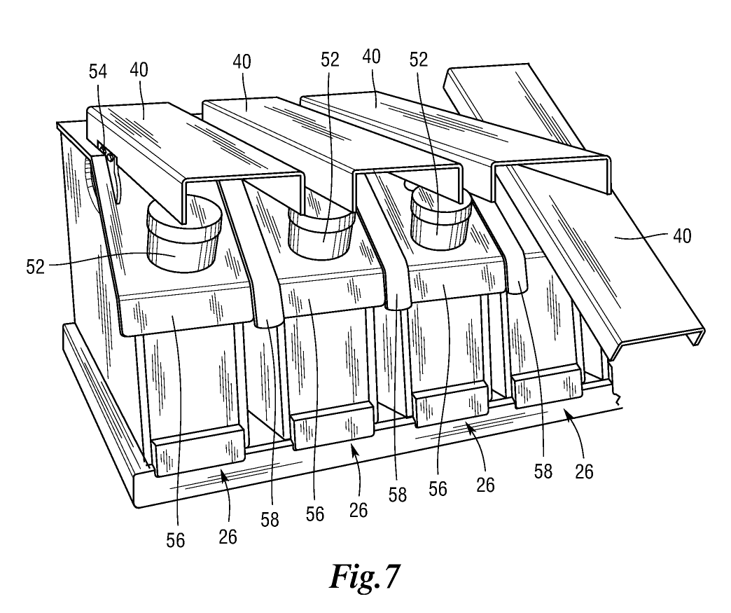

An array of motorized paddle assemblies 26 can be further sealed against dust and grit collecting between individual motorized paddle assemblies 26 as shown in FIG. 7. Sealing gaskets 58 are slid between the top plates 56 of the motorized paddle assemblies 26. This reduces the build up of grit between the motorized paddle assemblies 26 that could eventually pinch or sever any cable connections to/from the motorized paddle assemblies 26 or impede the range of motion of the hinges 54.

When the motorized paddle assembly 26 is at rest, a −5 VDC (Voltage, Direct Current) is applied to the leads (not shown) of the electromagnetic coil 44. This creates a magnetic field in the electromagnetic coil 44 that causes the electromagnetic coil 44 to swing on the shaft 46 and align itself to the appropriate opposite polarity of the magnets 48 and causes the paddle 40 to remain in the rest position. When the motorized paddle assembly 26 is actuated, a +16.5 VDC voltage is sent to the leads (not shown) of the electromagnetic coil 44 that causes the electromagnetic coil 44 to align itself with the magnets 48 towards the front of the housing 42. This correspondingly causes the paddle 40 to swing outwards. A −5 VDC current is applied to return the paddle 40 to the retracted position. Shock absorbers 52 absorb some of the vibration experienced by the paddle 40 during actuation and return.

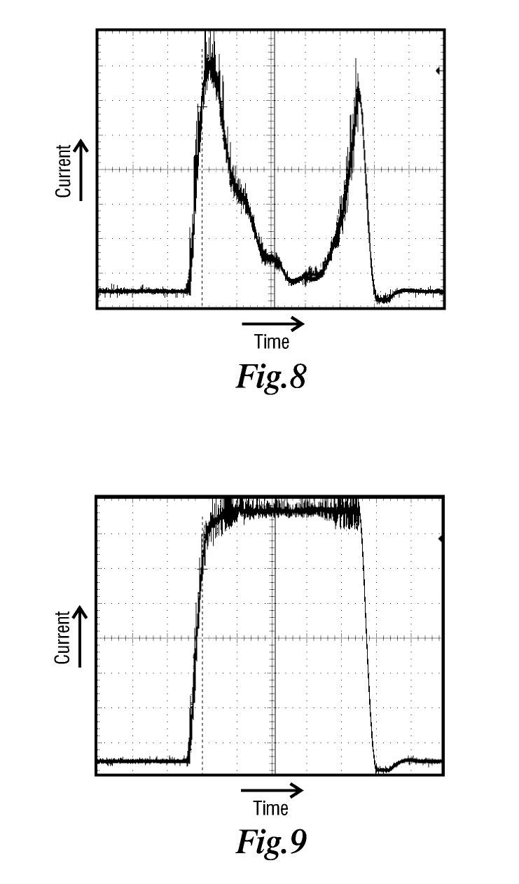

The motorized paddle assembly cable connector 50 allows the control circuitry to monitor signals received from the motorized paddle assembly 26 and to provide signals to the motorized paddle assembly 26 as needed. When a motorized paddle assembly 26 is actuated, a current signal is measured in the control circuitry. If the motorized paddle assembly 26 is operating normally this signal has a characteristic shape as shown in FIG. 8. A paddle 40 that is physically blocked results in a current signal with a very different shape, as shown in FIG. 9. A motorized paddle assembly 26 with an open circuit (i.e. a wire is broken, a connector is unplugged, or a fuse is blown) draws no current at all, resulting in a signal that is basically a flat line.

By using a pattern-recognition algorithm, it is possible to distinguish between these signal shapes, and detect the failed sorting assemblies. Such monitoring allows an operator of these modules to quickly determine which, if any, paddles in a sorter system need repair or replacement during routine maintenance and can provide warnings of failures during system startup and/or shutdown. Prior art sorters without such diagnostics features would require significant downtime to manually check each sorter component.

It would also be possible to perform such diagnostics while the module is in operation. However, the current waveform generated when a paddle strikes an object is different than that shown in FIGS. 8 and 9 and must be properly accounted for to avoid causing false indications of a failed paddle. While the configuration presented senses current only on the positive output, i.e., when the paddle is extended (this is known as “high-side” monitoring), it would be possible to monitor both positive and negative outputs (“high-side” and “low-side”).

Referring to FIGS. 1, 3, 4, and 6A-C, when a material stream is deposited on the material handling system 16 of a sorter 10, the material stream is transported through the detection range of the sensors 30 on the control modules 36. When a material matching the sensor's 30 programmed profile passes through sensor's 30 detection range, the signal input from the sensor 30 to the control circuitry 34 registers a detection of the target material. After a predetermined (adjustable) travel time (based on the speed that the material stream travels on the material handling system 16), the control circuitry 34 applies a positive voltage to the motorized paddle assembly's 26 electromagnetic coil 44 to actuate the paddle 40. The control circuitry 34 allows enough time for the paddle 40 to eject the sensed material from the material stream and then applies the negative voltage to pull the paddle 40 back to the rest position.

An array of control modules comprising at least two modules each with at least two sensors and two associated sorting assemblies could be used to retrofit existing sorter machines. The sensors would have to be positioned to detect target types of material in a material stream in a material handling system. The sorting assemblies could be aligned to properly sort the appropriate materials as needed. The number of control modules used in such an array would depend on the number, range, and size of the sensors and the paddles in each control module.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A sorter for sorting materials in a material stream, the material stream including a plurality of types of materials, said sorter comprising a material handling system having a width across which the material stream is deposited for transporting the material stream across the sorter, said sorter comprising:
at least two control modules, each said control module including control circuitry, at least two sensors, and a motorized paddle assembly for each said sensor, said control modules arranged to allow the detection of at least one type of material in the material stream;
each said sensor capable of detecting at least one type of material in the material stream, each said sensor capable of transmitting data to and receiving signals from said control circuitry;
each said motorized paddle assembly capable of being actuated by said control circuitry to substantially sort materials from the material stream based on the readings of its corresponding said sensor; and
said control circuitry capable of receiving signals from and transmitting signals to each said sensor and each said motorized paddle assembly.

2. The sorter of claim 1 in which said control circuitry is capable of maintaining logs of the activity and performance of each said at least two sensors and each said motorized paddle assembly.

3. The sorter of claim 1 in which said control circuitry is able to monitor at least one of: a failure in said sensor, an open circuit in said motorized paddle assembly, and whether said motorized paddle assembly is stuck.

4. The sorter of claim 1 in which at least one said control module comprises six said sensors and a corresponding motorized paddle assembly for each said sensor.

5. The sorter of claim 1 comprising six said control modules.

6. The sorter of claim 1 in which at least one said control modules has a different number of said sensors from the other said control modules.

7. The sorter of claim 1 in which said sensors of each said control module is configured to detect a type of material from the material stream from the group consisting of metal, plastics, glass, size, or color.

8. The sorter of claim 1 in which each said sensor in each said control module is an induction system, an X-Ray Fluorescence system, an optical detection system, or a near-infrared detection system.

9. The sorter of claim 1 in which at least one said control modules comprises a different sensor technology from the other said control modules.

10. The sorter of claim 1 in which at least one said control modules detects and sorts a different component of the material in the material stream from the other said control modules.

11. An array of control modules for a sorter for sorting materials in a material stream, the material stream including a plurality of types of materials, the sorter comprising a material handling system having a width across which the material stream is deposited for transporting the material stream across the sorter, said array of control modules comprising:
at least two control modules, each said control module including control circuitry, at least two sensors, a corresponding sorting assembly for each said sensor, and a user interface to control and monitor each said control module,
each said sensor capable of detecting at least one type of material in the material stream, each said sensor capable of transmitting data to and receiving signals from said control circuitry;
each said sorting assembly capable of being actuated by said control circuitry to substantially sort materials from the material stream based on the readings of its corresponding said sensor;
said control circuitry capable of receiving signals from and transmitting signals to each said sensor and each said sorting assembly; and
said at least two control modules arranged on the sorter to allow the detection of at least one type of material in the material stream.

12. The array of control modules of claim 11 in which said control circuitry is capable of maintaining logs of the activity and performance of each said at least two sensors and each said sorting assembly.

13. The array of control modules of claim 11 in which said control circuitry is able to monitor at least one of: a failure in said sensor, an open circuit in said sorting assembly, and whether said sorting assembly is stuck.

14. The array of control modules of claim 11 in which each said control module comprises six said sensors and six corresponding sorting assemblies.

15. The array of control modules of claim 11 comprising six said control modules.

16. The array of control modules of claim 11 in which at least one said control module has a different number of said sensors from the other said control modules.

17. The array of control modules of claim 11 in which said sensors of each said control module is configured to detect a type of material from the material stream from the group consisting of metal, plastics, glass, size, or color.

18. The array of control modules of claim 11 in which each said sensor in each said control module is an induction system, an X-Ray Fluorescence system, an optical detection system, or a near-infrared detection system.

19. The array of control modules of claim 11 in which at least one said control module comprises a different sensor technology from the other said control modules.

20. The array of control modules of claim 11 in which at least one said control module detects and sorts a different component of the material in the material stream from the other said control modules.

21. A sorter for sorting materials in a material stream, the material stream including a plurality of types of materials, said sorter comprising a material handling system having a width across which the material stream is deposited for transporting the material stream across the sorter, said sorter comprising:
an array of control modules, said array of control modules comprising at least two control modules, each said control module including:
a sensor means for detecting at least one type of material in the material stream and transmitting data to and receiving signals from said control means;
a corresponding sorting means for each said sensor means, said sorting means for substantially sorting materials from the material stream based on the readings of its corresponding said sensor means; and
a control means for receiving signals from and transmitting signals to each said sensor means, and actuating each said sorting means.

22. An array of control modules for a sorter for sorting materials in a material stream, the material stream including a plurality of types of materials, said sorter comprising a material handling system having a width across which the material stream is deposited for transporting the material stream across the sorter, said array of control modules comprising:
a user interface means for controlling and monitoring each said control module in said array of control modules, and
at least two control modules, each said control module including:
a sensor means for detecting at least one type of material in the material stream and transmitting data to and receiving signals from said control means;
a corresponding sorting means for each said sensor means, said sorting means for substantially sorting materials from the material stream based on the readings of its corresponding said sensor means; and
a control means for receiving signals from and transmitting signals to each said sensor means, and actuating each said sorting means.

23. A control module for a sorter comprising at least two control modules, the sorter for sorting a plurality of types of materials from a material stream and comprising a material handling system having a width across which the material stream is deposited for transporting the material stream across the sorter, said control module comprising:
control circuitry, at least two sensors, and a corresponding sorting assembly for each said sensor;
each said sensor capable of detecting at least one type of material in the material stream, each said sensor capable of transmitting data to and receiving signals from said control circuitry;
each said sorting assembly capable of being actuated by said control circuitry to substantially sort materials from the material stream based on the readings of its corresponding said sensor; and
said control circuitry capable of receiving signals from and transmitting signals to each said sensor and each said sorting assembly.

24. The control module of claim 23 in which said control circuitry is capable of maintaining logs of the activity and performance of each said at least two sensors and each said sorting assembly.

25. The control module of claim 23 in which said control circuitry is able to monitor at least one of: a failure in said sensor, an open circuit in said sorting assembly, and whether said sorting assembly is stuck.

26. The control module of claim 23 in which said control module comprises six said sensors and six corresponding sorting assemblies.

27. The control module of claim 23 in which said sensors are configured to detect a type of material from the material stream from the group consisting of metal, plastics, glass, size, or color.

28. The control module of claim 23 in which said sensors are an induction system, an X-Ray Fluorescence system, an optical detection system, or a near-infrared detection system.

29. A control module for a sorter comprising of at least two control modules, the sorter for sorting materials in a material stream, the material stream including a plurality of types of materials, the sorter comprising a material handling system having a width across which the material stream is deposited for transporting the material stream across the sorter, said control module comprising:
a sensor means for detecting at least one type of material in the material stream and transmitting data to and receiving signals from said control means;
a corresponding sorting means for each said sensor means, said sorting means for substantially sorting materials from the material stream based on the readings of its corresponding said sensor means; and
a control means for receiving signals from and transmitting signals to each said sensor means, and actuating each said sorting means.
